(19) United States
(12) Patent Application Publication
(10) Pub. No.: US 2004/0101627 A1
(43) Pub. Date: May 27, 2004

(54) Method of coating wooden slats

(76) Inventor: Lyle Zastrow, Irvine, CA (US)

Correspondence Address: Klein O'Neill & Singh, LLP, Suite 510, 2 Park Plaza, Irvine, CA, 92614, US

(21) Appl. No.: 10/304,301

(22) Filed: Nov. 26, 2002

(51) Int. Cl. B05D 3/02; B05D 1/36

(52) U.S. Cl. 427/407.1; 427/393

(57) ABSTRACT

The present invention relates to a method of coating a wooden component, such as a slat. The method includes the following steps: applying a pigmented or sheen-enhanced lacquer coating onto a first surface of the component; drying the lacquer coating on the first surface; flipping the wooden component; applying a pigmented or sheen-enhanced lacquer coating onto a second surface of the wooden component; drying the lacquer coating on the second surface; applying a UV-cured polymer coating to one of the lacquer coated surfaces; flash curing the polymer and lacquer coated surface; flipping the wooden component; applying a UV-cured polymer coating to the other side of the lacquer coated surface; and flash curing the polymer and lacquer coated surface.

### CROSS-REFERENCE TO RELATED APPLICATION

Not Applicable

### FEDERALLY-SPONSORED RESEARCH OR DEVELOPMENT

Not Applicable

### BACKGROUND OF THE INVENTION

The present invention relates to a method of coating wooden components, particularly wooden slats, such as the slats used to make wooden blinds and shutters and the like.

In the manufacture of wooden components, particularly the slat used for blinds or shutters, the component is commonly finished with a lacquer or UV-cured polymer coating. In the conventional process, each surface of the component or slat is first coated with an inert, colorless, flat (non-glossy) base coat, which is then dried. A top coat, containing pigment and/or sheen (gloss) is then applied over the base coat. The top coat is either a lacquer or a UV-cured polymer.

It would be desirable to be able to apply a clear UV-cured polymer coating on top of a lacquer coating containing the desired pigment and/or sheen. In other words, it would be desirable to provide both a pigmented and/or sheen-enhanced lacquer coating and a UV-cured polymer coating on top of the lacquer. Using conventional coatings, however, this would require three coatings (including the base coat) for each surface. Moreover, the UV-curing of the topmost polymer coating may tend to cause bubbling or other irregularities in the underlying lacquer coating.

It has been deemed desirable to eliminate the need for a separate base coating, and to allow a clear UV-cured polymer coating to be applied to a single coating of pigmented and/or sheen-enhanced lacquer without degrading the underlying lacquer. Conventional lacquer formulations, however, have not permitted this.

### SUMMARY OF THE INVENTION

It is one object of the present invention to provide a method of coating wooden components, such as the slats used in wooden blinds and shutters, with a pigmented or sheen-enhanced lacquer coat and a finishing UV-cured polymer top coat.

In a first preferred embodiment of the present invention, the method comprises applying a first coat of nitrocellulose lacquer formulation on each side of the wooden component. The lacquer coat is then dried at elevated temperatures.

As a second step, the nitrocellulose lacquer coated wooden component is further coated with an ultraviolet (UV) cured polymer formulation on each side, and then flash cured to dry the coat.

In a specific embodiment, a nitrocellulose lacquer formulation and a UV-cured polymer formulation are selected to ensure effective coating of both the formulations on the wooden components. The solvent base of both the compositions is selected to ensure that the coatings are not damaged during and after application.

The present invention offers a number of advantages over prior art coating methods and formulations. For example, the method of the present invention obviates the use of a primer as a base coat, in that here pigmented and/or sheen-enhanced nitrocellulose lacquer coat is directly applied to the surface of the component.

Furthermore, the method of coating of the present invention provides an effective combination of a pigmented and/or sheen-enhanced lacquer first coat and a clear UV-cured polymer top coat. Special lacquer and UV-cured polymer formulations are used to attain the specific combination of the two coats.

In yet another aspect of the present invention, the combination coating applied in the method of the invention provides improved moisture resistance, scratch resistance, and fire retardant characteristics. Moreover, it provides a nonmetal marring finish with improved consistency of the look of the finish throughout a single component, and from component to component.

The present invention may be understood through the following description with reference to the accompanying drawings.

### BRIEF DESCRIPTION OF THE DRAWINGS

FIG. 1 is a flow diagram showing various steps for applying a nitrocellulose lacquer coating on wood, according to the present invention.

FIG. 2 is a flow diagram showing application of a UV-cured polymer coating on a lacquer coated wooden component in accordance with the present invention.

### DETAILED DESCRIPTION OF THE PRESENT INVENTION

The present invention will now be described in more detail with reference to the following embodiments. It is to be noted that the following descriptions of the preferred embodiments of this invention are presented herein for the purpose of illustration and description only. It is not intended to be exhaustive or to be limited to the precise form disclosed.

In an embodiment of the present invention, the lacquer formulation used for coating the wooden components comprises the following essential ingredients:

| INGREDIENT | % by weight | CAS NO: |
|---|---|---|
| Calcium Carbonate | 1-5 | 1317-65-3 |
| Aluminum Trihydroxide | 1-5 | 21645-51-2 |
| Epoxidized Soybean Oil | 1-5 | 8013-07-8 |
| Isopropanol | 1-5 | 67-63-0 |
| Ethyl Acetate | 1-5 | 141-78-6 |
| Diisononyl Pthalate | 5-15 | 68515-48-0 |
| Dimethyl Ketone (Acetone) | 5-15 | 67-64-1 |
| Nitrocellulose | 5-15 | 9004-70-0 |
| Toluene | 13-15 | 108-88-3 |
| Methyl Ethyl Ketone | 13-15 | 78-93-3 |
| Butyl acetate | 1-5 | 123-86-4 |
| Talc | 1-5 | 14807-96-6 |

Besides these essential components, the formulation additionally comprises conventional ingredients selected from surfactants, pigments, surfactants and/or solvents.

In a more preferred embodiment, the formulation comprises 13.91% by weight toluene and 14.55% by weight methyl ethyl ketone.

In an exemplary embodiment, butyl acetate in the lacquer coating formulation is replaced by acetic acid or butyl ester or butyl ethanoate.

The UV-cured polymer formulation as used to apply a second coat on the wooden blinds, according to one aspect of the present invention comprises the following essential ingredients:

| INGREDIENT | % by weight | CAS NO: |
|---|---|---|
| Tripropylene Glycol | 35-45 | 042978-66-5 |
| Diacrylate | | |
| Epoxy Acrylate | 25-35 | 055818-57-0 |
| NPG Propoxylate Diacrylate | 5-15 | 084170-74-1 |
| Benzophenone | 1-5 | 000119-61-9 |
| Trimethylolpropane Triacrylate | 1-5 | 015625-89-5 |
| Acrylated Amine | 1-5 | |
| Hydroxymethylphenylpropanone | 1-5 | 7473-98-5 |
| Hydroxycyclohexylphenyl ketone | 1-5 | 947-19-3 |

Besides these essential components, the formulation additionally comprises other conventional ingredients selected from additives and/or surfactants.

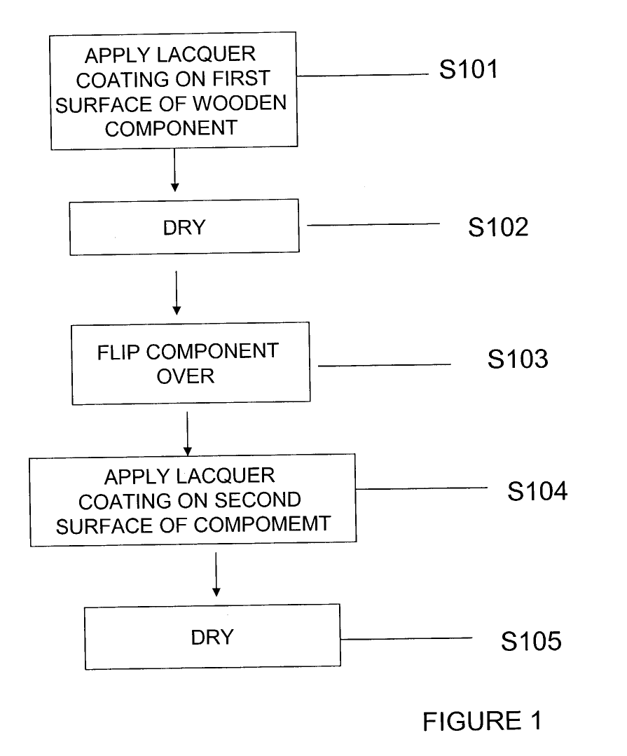

FIG. 1 illustrates the steps for coating the wooden components with a nitrocellulose lacquer coat in one aspect of the present invention.

In step S101, a first side of a wooden component (e.g., a component of a blind or shutter, such as a slat, valance or bottom rail) is passed on a conveyor belt to coat a first side or surface of the wooden component with a pigmented or sheen-enhanced nitrocellulose lacquer formulation. In an exemplary embodiment, the component is advanced at the rate of approximately 10 linear feet (305 cm) per second, with the coating applied to a wet thickness of 6 mils (0.15 mm).

In step S102, the lacquer coating on the first surface or side is dried at an elevated temperature, e.g., approximately 40C.-42° C. This may be done by passing the coated wooden component through a heat tunnel. Typical drying time would be about 6.5 minutes In step S103, the wooden component is flipped to coat the second surface or side with the lacquer coat, as shown in step S104. The coating on the second side or surface is then dried, as described above, in step S105.

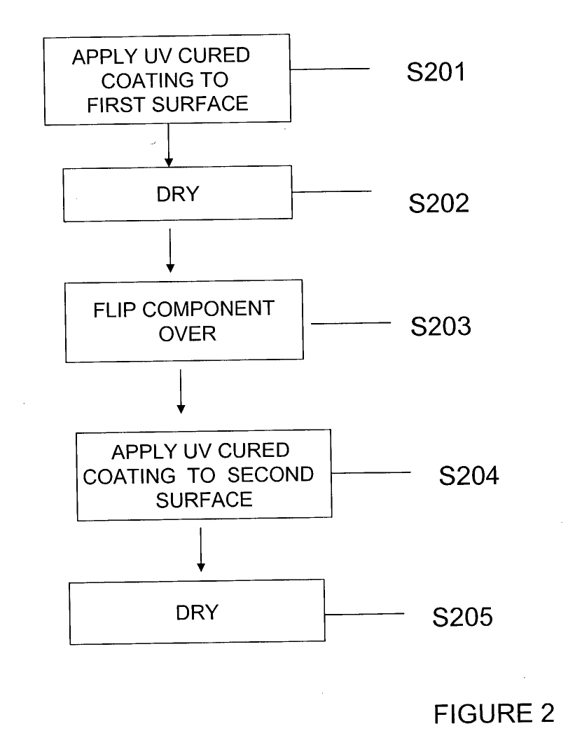

FIG. 2 illustrates the process steps for applying a clear UV-cured polymer coating as a finishing or top coat over the lacquer coated wooden component described above with respect to FIG. 1.

In step S201, the nitrocellulose lacquer-coated wooden component is coated with the clear UV-cured polymer formulation. In an exemplary embodiment, the UV-cured formulation may be applied by passing the lacquer-coated wooden component on a conveyor belt to expose one of the surfaces or sides of the wooden component to the UV-cured polymer coating. In an exemplary embodiment of the invention, the component is advanced at the rate of approximately 16 linear inches (41 cm) per second. In this step a polymer coating of approximately 0.004 mm (±0.0013 mm) in thickness is applied in the exemplary embodiment.

Next, in step S202, the UV-cured polymer on the lacquer coated surface of the wooden component is flash cured at approximately 700 C. Then, in step S203, the wooden component is flipped for the application of the UV-cured polymer coating to the other side or surface of the wooden component (step S204). In the exemplary embodiment, the step of applying the UV-cured polymer coating to the other side or surface of lacquer-coated wooden component (step S204) is performed in the same way as the step of applying the UV-cured polymer coating to the first side or surface of the component (step S201).

In step S205, the UV-cured polymer coating on the other side or surface of the wooden component is flash cured at approximately 700 C.

It is within the scope of the present invention to apply the lacquer coating by spraying, curtain coating, or roller coating. It is also within the scope of the present invention to spray or roller coat the UV-cured polymer formulation as a finishing coat on the wooden components. The application of the UV-cured polymer formulation may also be a continuous process by using two sets of rollers and two sets of curing lamps.

While the invention has been described in terms of what are presently considered to be the preferred embodiments, it is to be understood that the invention need not be limited to the disclosed embodiment. On the contrary it is intended to cover various modifications and similar arrangements included within the spirit and scope of the appended claims that are to be accorded with the broadest interpretation so as to encompass all such modifications and similar structures.

What is claimed is:

1. A method of coating a surface of a wooden component, comprising the steps of:
(a) applying a pigmented or sheen-enhanced lacquer coating onto the surface;
(b) drying the lacquer coating;
(c) applying a UV-cured polymer coating to the lacquer coated surface; and
(d) flash curing the polymer coating.

2. The method of claim 1, wherein the lacquer coating is a composition consisting essentially of calcium carbonate, aluminum trihydroxide, epoxidized soybean oil, isopropanol, ethyl acetate, diisononyl phthalate, dimethyl ketone, nitrocellulose, toluene, methyl ethyl ketone, talc and butyl acetate.

3. The method of claim 2, wherein the lacquer coating composition additionally comprises conventional ingredients selected from surfactants, pigments, surfactants and/or solvents.

4. The method of claim 1, wherein the UV-cured polymer coating is a composition comprising essentially of tripropylene glycol diacrylate, epoxy acrylate, NPG Propoxylate diacrylate, benzophenone, trimethylolpropane triacrylate, acrylated amine, hydroxymethylphenylproanone and hydroxycyclohexylphenyl ketone.

5. The method of claim 4, wherein the UV-cured polymer coating composition additionally comprises conventional ingredients selected from additives and/or surfactants.

6. The method of claim 1, wherein the lacquer coating is applied on to a surface of the wooden component by advancing the component at the rate of approximately 305 cm per second.

7. The method of claim 1, wherein lacquer coating is dried at an elevated temperatures of 40° C.-42° C.

8. The method of claim 1, wherein the UV cured coating is applied on the lacquer coated wooden component by advancing the component at the rate of approximately 41 cm per second.

9. The method of claim 1, wherein UV cured polymer coating is flash cured at approximately 700° C.

10. A method of coating a wooden component having a first and second opposed surfaces, comprising the steps of:
(a) applying a pigmented or sheen-enhanced lacquer coating onto a first surface;
(b) drying the lacquer coating on the first surface;
(c) flipping the wooden component;
(d) applying a pigmented or sheen-enhanced lacquer coating onto the second surface;
(e) drying the lacquer coating on the second surface;
(f) applying a UV-cured polymer coating to one of the lacquer coated surfaces;
(g) flash curing the polymer and lacquer coated surface;
(h) flipping the wooden component;
(i) applying a UV-cured polymer coating to the other side of the lacquer coated surface; and
(g) flash curing the polymer and lacquer coated surface.

11. The method of claim 10, wherein the lacquer coating is a composition consisting essentially of calcium carbonate, aluminum trihydroxide, epoxidized soybean oil, isopropanol, ethyl acetate, diisononyl phthalate, dimethyl ketone, nitrocellulose, toluene, methyl ethyl ketone, talc and butyl acetate.

12. The method of claim 11, wherein the lacquer coating composition additionally comprises conventional ingredients selected from surfactants, pigments, surfactants and/or solvents.

13. The method of claim 10, wherein the UV-cured polymer coating is a composition comprising essentially of tripropylene glycol diacrylate, epoxy acrylate, NPG Propoxylate diacrylate, benzophenone, trimethylolpropane triacrylate, acrylated amine, hydroxymethylphenylproanone and hydroxycyclohexylphenyl ketone.

14. The method of claim 13, wherein the UV-cured polymer coating composition additionally comprises conventional ingredients selected from additives and/or surfactants.

15. The method of claim 10, wherein the lacquer coating is applied on to a surface of the wooden component by advancing the component at the rate of approximately 305 cm per second.

16. The method of claim 10, wherein lacquer coating is dried at an elevated temperatures of 40° C.-42° C.

17. The method of claim 10, wherein the UV cured coating is applied on the lacquer coated wooden component by advancing the component at the rate of approximately 41 cm per second.

18. The method of claim 10, wherein UV cured polymer coating is flash cured at approximately 700° C.
